(19) United States
(12) Patent Application Publication
(10) Pub. No.: US 2012/0250527 A1
(43) Pub. Date: Oct. 4, 2012

(54) Determining Connectivity Of A High Speed Link That Includes An AC-Coupling Capacitor

(75) Inventors: Tae Hong Kim, Round Rock, TX (US); Pravin S. Patel, Cary, NC (US)

(73) Assignee: INTERNATIONAL BUSINESS MACHINES CORPORATION, Armonk, NY (US)

(21) Appl. No.: 13/072,863

(22) Filed: Mar. 28, 2011

(51) Int. Cl. H04L 12/26

(52) U.S. Cl. 370/248

(57) ABSTRACT

Methods, apparatuses, and computer products are provided for determining connectivity of a high speed link that includes an ac-coupling capacitor. Embodiments include transmitting, by a connectivity tester, a test signal on a lane within the high speed link; detecting on the lane, by the connectivity tester, a standing wave generated in response to the transmission of the test signal; determining, by the connectivity tester, whether the standing wave is resonating; if the standing wave is resonating, indicating, by the connectivity tester, that the lane of the high speed link has a closed connection; and if the standing wave is not resonating, indicating, by the connectivity tester, that the lane of the high speed link has an open connection.

### BACKGROUND OF THE INVENTION

1. Field of the Invention

The field of the invention is data processing, or, more specifically, methods, apparatus, and products for determining connectivity of a high speed link that includes an ac-coupling capacitor.

2. Description of Related Art

AC-coupling capacitors are used in high speed link to eliminate DC voltage and pass AC signals. However, when the AC-coupling capacitor is inside the connectors of the high speed link, checking the connectivity of the high speed link may be complicated.

### SUMMARY OF THE INVENTION

Methods, apparatuses, and computer products are provided for determining connectivity of a high speed link that includes an ac-coupling capacitor. Embodiments include transmitting, by a connectivity tester, a test signal on a lane within the high speed link; detecting on the lane, by the connectivity tester, a standing wave generated in response to the transmission of the test signal; determining, by the connectivity tester, whether the standing wave is resonating; if the standing wave is resonating, indicating, by the connectivity tester, that the lane of the high speed link has a closed connection; and if the standing wave is not resonating, indicating, by the connectivity tester, that the lane of the high speed link has an open connection.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a diagram of a system for determining connectivity of a high speed link that includes an ac-coupling capacitor according to embodiments of the present invention.

FIG. 2 sets forth a diagram of automated computing machinery comprising an exemplary computer useful in determining connectivity of a high speed link that includes an ac-coupling capacitor according to embodiments of the present invention.

FIG. 3 sets forth a diagram illustrating a spectrum of the signals on a lane of a high speed link that includes an ac-coupling capacitor.

FIG. 4 sets forth a flow chart illustrating an example of a method for determining connectivity of a high speed link that includes an ac-coupling capacitor according to embodiments of the present invention.

FIG. 5 sets forth a flow chart illustrating another example of a method for determining connectivity of a high speed link that includes an ac-coupling capacitor according to embodiments of the present invention.

FIG. 6 sets forth a flow chart illustrating another example of a method for determining connectivity of a high speed link that includes an ac-coupling capacitor according to embodiments of the present invention.

### DETAILED DESCRIPTION OF EXEMPLARY EMBODIMENTS

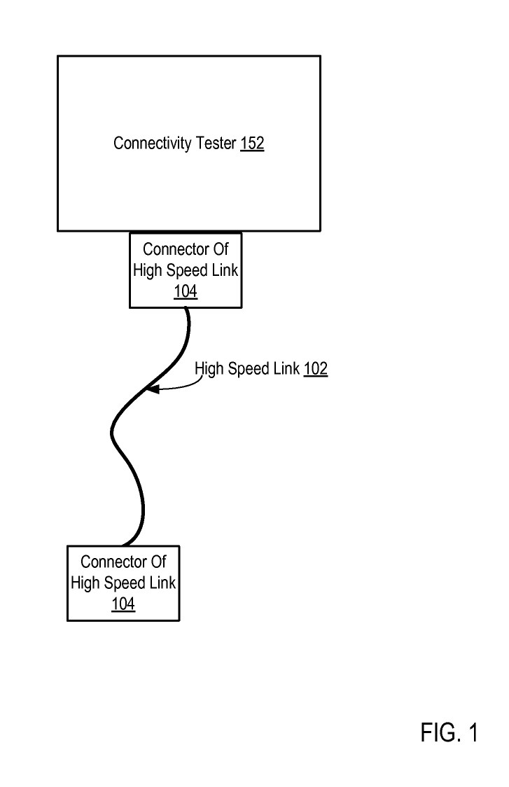

Exemplary methods, apparatus, and products for determining connectivity of a high speed link that includes an ac-coupling capacitor in accordance with the present invention are described with reference to the accompanying drawings, beginning with FIG. 1. FIG. 1 sets forth a diagram of a system for determining connectivity of a high speed link that includes an ac-coupling capacitor according to embodiments of the present invention. The system of FIG. 1 includes a high speed link (102) with connectors (104) on each end. A high speed link may be an active cable that uses a silicon chip to boost performance of the cable during data transmission.

To test the connectivity of the high speed link (102) or the connectors (104) on each end of the high speed link (102), a connectivity tester (152) is coupled to one or more connectors (104) of the high speed link (102). Connectors of the high speed link are electrical interfaces for a particular type of connection, such as Peripheral Component Interconnect express (PCIe), InfinitBand, High Definition Multimedia Interface (HDMI), Universal Serial Bus (USB), ect. The connectivity tester (152) of FIG. 1 is configured to determine if the high speed link (102) is open or closed. If the high speed link (102) is open, then signals may not pass through a lane in the high speed link (102). For example, an ac-coupling capacitor within the connector (104) of the high speed link (102) may prevent the transfer of a signal. An ac-coupling capacitor may be used in the connector to connect two circuits such that only the AC signal from the first circuit can pass through to the next circuit while the DC signal is blocked. This technique helps to isolate the DC bias settings of the two coupled circuits.

To determine if the high speed link (102) is open or closed, the connectivity tester (152) is configured to transmit a test signal on a lane within the high speed link (102); detecting on the lane a standing wave generated in response to the transmission of the test signal; determining whether the standing wave is resonating; if the standing wave is resonating, indicating that the lane of the high speed link has a closed connection; and if the standing wave is not resonating, indicating that the lane of the high speed link has an open connection. Various embodiments of the present invention may be implemented on a variety of hardware platforms in addition to those illustrated in FIG. 1.

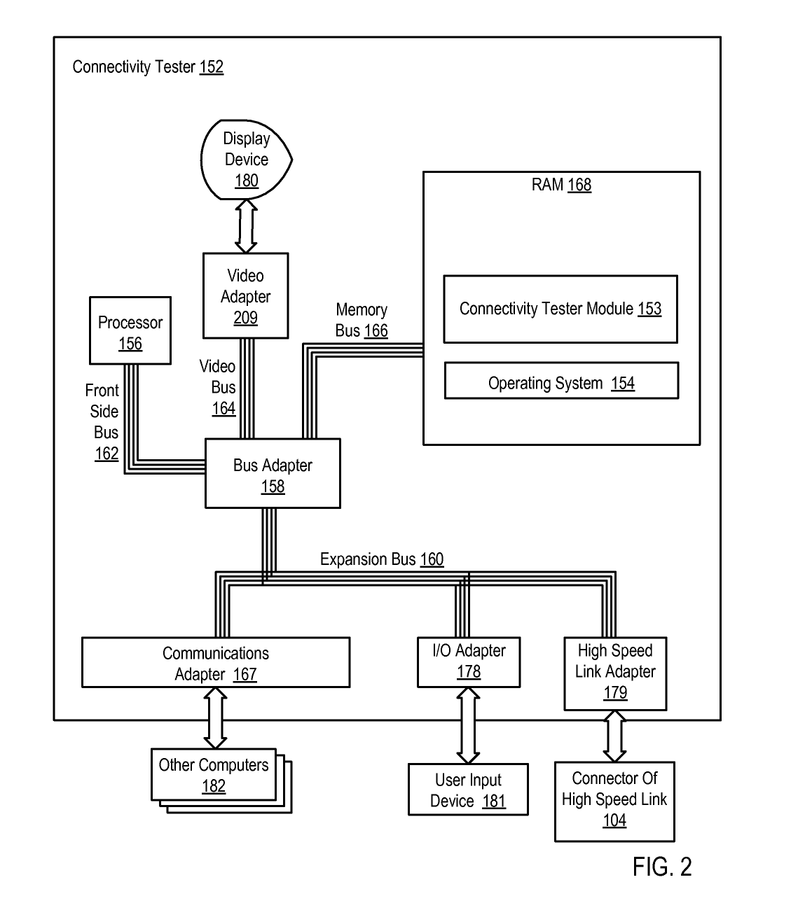

Determining connectivity of a high speed link that includes an ac-coupling capacitor in accordance with the present invention is generally implemented with computers, that is, with automated computing machinery. In the system of FIG. 1, for example, the connectivity tester (152) is implemented to some extent at least as computers. For further explanation, therefore, FIG. 2 sets forth a block diagram of automated computing machinery comprising an example of a connectivity tester (152) useful in determining connectivity of a high speed link that includes an ac-coupling capacitor according to embodiments of the present invention. The connectivity tester (152) of FIG. 2 includes at least one computer processor (156) or ‘CPU’ as well as random access memory (168) (‘RAM’) which is connected through a high speed memory bus (166) and bus adapter (158) to processor (156) and to other components of the connectivity tester (152).

Stored in RAM (168) is a connectivity tester module (153) that includes computer program instructions for determining connectivity of a high speed link that includes an ac-coupling capacitor according to embodiments of the present invention. When the processor (156) executes the computer program instructions, the computer program instructions cause the computer processor (156) to transmit a test signal on a lane within the high speed link; detect on the lane a standing wave generated in response to the transmission of the test signal; determine whether the standing wave is resonating; if the standing wave is resonating, indicate that the lane of the high speed link has a closed connection; and if the standing wave is not resonating, indicate that the lane of the high speed link has an open connection.

Also stored in RAM (168) is an operating system (154). Operating systems useful determining connectivity of a high speed link that includes an ac-coupling capacitor according to embodiments of the present invention include UNIX™, Linux™, Microsoft XP™, AIX™, IBM's i5/OS™, and others as will occur to those of skill in the art. The operating system (154) and the connectivity tester module (153) in the example of FIG. 2 are shown in RAM (168), but many components of such software typically are stored in non-volatile memory also, such as, for example, on a disk drive. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example connectivity tester (152) of FIG. 2 includes one or more input/output (‘I/O’) adapters (178). I/O adapters implement user-oriented input/output through, for example, software drivers and computer hardware for controlling output to display devices such as computer display screens, as well as user input from user input devices (181) such as keyboards and mice. The example connectivity tester (152) of FIG. 2 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary connectivity tester (152) of FIG. 2 includes a communications adapter (167) for data communications with other computers (182) and for data communications with a data communications network. Such data communications may be carried out serially through RS-232 connections, through external buses such as a Universal Serial Bus (USW), through data communications networks such as IP data communications networks, and in other ways as will occur to those of skill in the art. Communications adapters implement the hardware level of data communications through which one computer sends data communications to another computer, directly or through a data communications network. Examples of communications adapters useful for determining connectivity of a high speed link that includes an ac-coupling capacitor according to embodiments of the present invention include modems for wired dial-up communications, Ethernet (IEEE 802.3) adapters for wired data communications network communications, and 802.11 adapters for wireless data communications network communications.

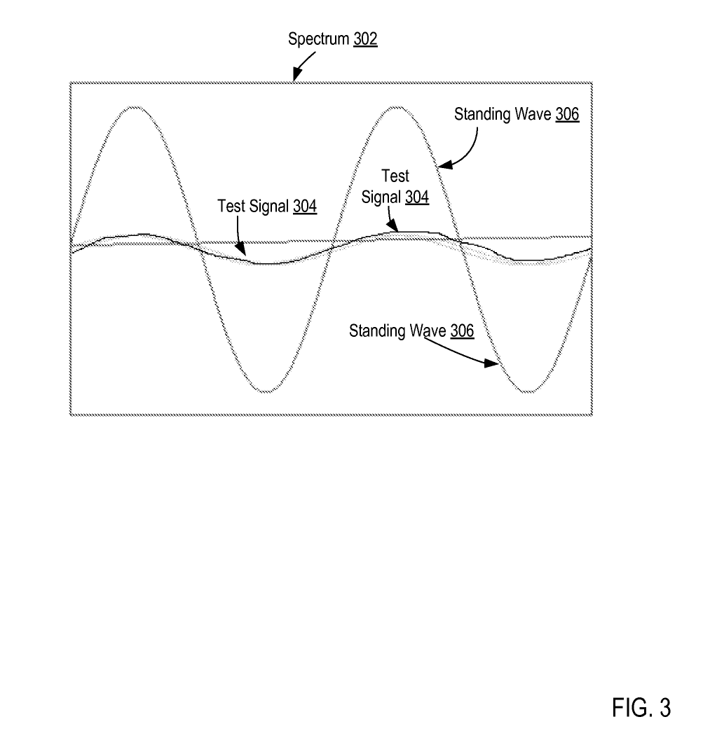

FIG. 3 sets forth a diagram illustrating a spectrum of the signals on a lane of a high speed link that includes an ac-coupling capacitor. The spectrum (302) of FIG. 3 includes a test signal (304) that is applied by a connectivity tester to a high speed link. In response to the test signal (304) being applied to the high speed link, a standing wave (306) is generated. Based on the spectrum, a connectivity tester may determine whether the standing wave (304) is resonating. If the standing wave is resonating, the connectivity tester may indicate that the high speed link is closed, and thus operating correctly. The spectrum (302) may be generated by spectrum generating circuitry within the connectivity tester (152) of FIGS. 1-2. Spectrum generating circuitry decomposes a complex signal into simpler parts during spectrum analysis for illustration of the signal.

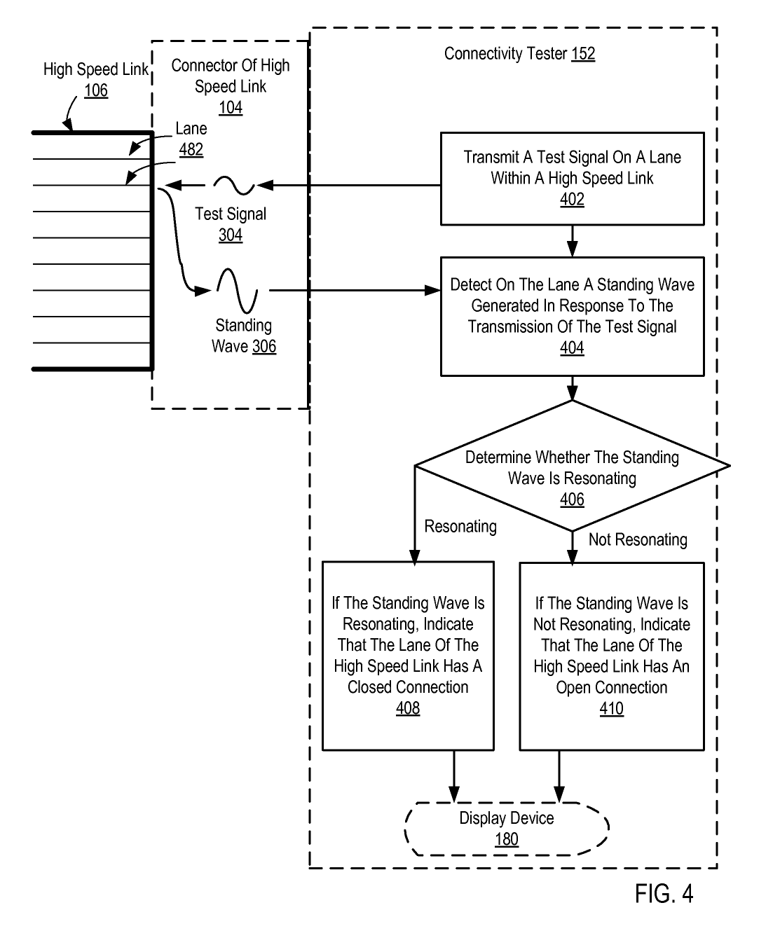

For further explanation, FIG. 4 sets forth a flow chart illustrating an exemplary method for determining connectivity of a high speed link that includes an ac-coupling capacitor according to embodiments of the present invention. The method of FIG. 4 includes transmitting (402), by a connectivity tester (152), a test signal (304) on a lane (482) within the high speed link (106). Transmitting (402) the test signal (304) on the lane (482) of the high speed link (106) may be carried out by establishing a connection between the connector (104) of the high speed link (104) and the connectivity tester (152), selecting a frequency of the test signal (304), selecting a particular lane of the high speed link (106) to test, and providing the test signal (304) on the particular lane.

The method of FIG. 4 also includes detecting (404) on the lane (482), by the connectivity tester (152), a standing wave (306) generated in response to the transmission of the test signal (304). Detecting (404) on the lane (482) the standing wave (306) may be carried out by monitoring the lane (482) for signals, storing the monitored signals within the connectivity tester (152), and analyzing the monitored signals for a standing wave by comparing the amplitude and frequency of the monitored signals against predetermined standing wave patterns.

The method of FIG. 4 includes determining (406), by the connectivity tester (152), whether the standing wave (306) is resonating. Determining (406) whether the standing wave (306) is resonating may be carried out by measuring the amplitude of the monitored standing wave (306) and comparing the amplitude of the monitored standing wave (306) against predetermined amplitude resonance thresholds.

The method of FIG. 4 also includes if the standing wave (306) is resonating, indicating (408), by the connectivity tester (152), that the lane (482) of the high speed link (106) has a closed connection. Indicating (408) that the lane (482) of the high speed link (106) has a closed connection may be carried out by displaying a spectrum on a display device of the connectivity tester and displaying a message on the display device of the connectivity tester.

The method of FIG. 4 includes if the standing wave (306) is not resonating, indicating (410), by the connectivity tester (152), that the lane (482) of the high speed link (104) has an open connection. Indicating (410) that the lane (482) of the high speed link (106) has an open connection may be carried out by displaying a spectrum on a display device of the connectivity tester and displaying a message on the display device of the connectivity tester.

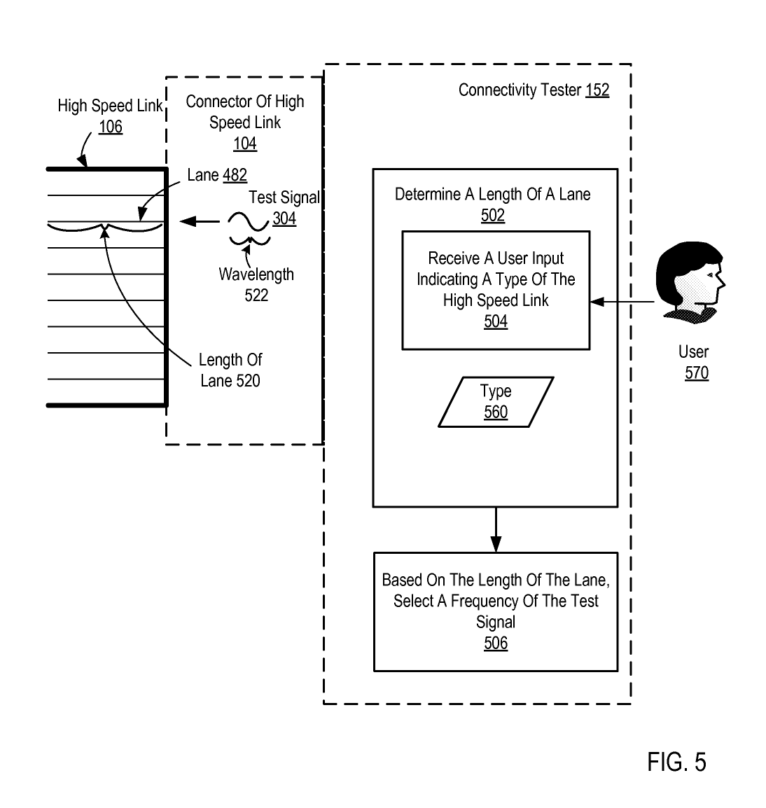

For further explanation, FIG. 5 sets forth a flow chart illustrating a further exemplary method for determining connectivity of a high speed link that includes an ac-coupling capacitor according to embodiments of the present invention

The method of FIG. 5 includes determining (502), by the connectivity tester (152), a length (520) of the lane (482) of the high speed link (106). Determining (502) a length of the lane (482) may be carried out by receiving (504), by the connectivity tester (152), a user input from a user (570) indicating a type (560) of the high speed link (106). The connectivity tester (152) may use the type (560) of the high speed link to determine the length (520) of the lane (482). For example, the connectivity tester (152) may store information that associates a particular type with a particular length. In this example, if the user (570) knows the type of the high speed link (106), the connectivity tester (152) may determine the length (520) of the high speed link (106) and thus determine if the high speed link (106) is open or closed.

The method of FIG. 5 also includes based on the length (520) of the lane (482), selecting (506), by the connectivity tester (152), a frequency of the test signal (304). Selecting (506) the frequency of the test signal may be carried out by determining the ratio of the length (520) of the lane (482) to the wavelength (522) of a particular frequency and selecting the frequency such that the ratio of the length (520) of the lane (482) of the high speed link (106) to the wavelength (522) of the frequency of the test signal (304) is an integer.

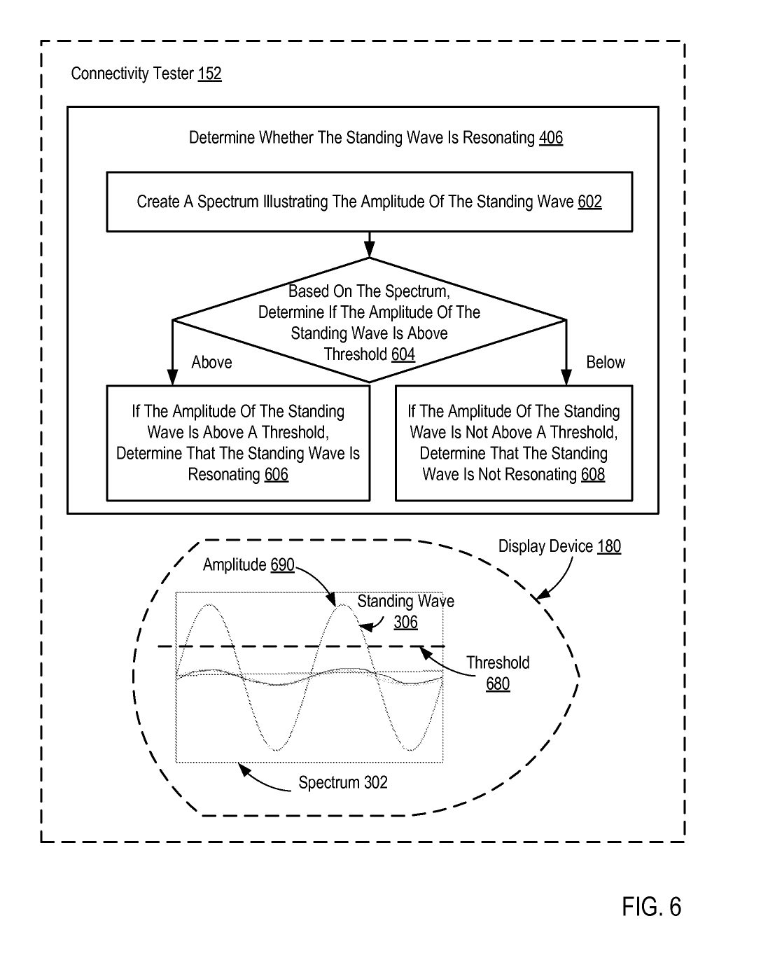

For further explanation, FIG. 6 sets forth a flow chart illustrating a further exemplary method for determining connectivity of a high speed link that includes an ac-coupling capacitor according to embodiments of the present. In the method of FIG. 6, determining (406) whether the standing wave is resonating includes creating (602), by the connectivity tester (152), a spectrum (302) illustrating the amplitude (690) of the standing wave (306). Creating (602) the spectrum (302) may be carried out using spectrum analyzing circuitry to analyze signals monitored from a lane of a high speed link and display the spectrum (302) on a display device (180) of the connectivity tester (152).

In the method of FIG. 6, determining (406) whether the standing wave (306) is resonating includes based on the spectrum (302), determining (604), by the connectivity tester (152), whether the amplitude (690) of the standing wave (306) is above a threshold. Determining (604) whether the amplitude (690) of the standing wave (306) is above a threshold (680) may be carried out measuring voltages of the standing wave (306) and comparing the measure voltage to the threshold (680).

In the method of FIG. 6, determining (406) whether the standing wave (306) is resonating includes if the amplitude (690) of the standing wave (306) is above the threshold (680), determining (606), by the connectivity tester (152), that the standing wave (306) is resonating. Determining (606) that the standing wave (306) is resonating based on if the amplitude (690) is above the threshold (680) may be carried out by measuring the amplitude (690) of the standing wave (306), comparing the amplitude (690) to the threshold (680) and storing an indication within the connectivity tester (152) that the standing wave (306) is resonating.

In the method of FIG. 6, determining (406) whether the standing wave (306) is resonating includes if the amplitude (690) of the standing wave (306) is below a threshold (680), determining (608), by the connectivity tester (152), that the standing wave is not resonating. Determining (608) that the standing wave (306) is not resonating based on if the amplitude (690) is below a threshold (680) may be carried out by measuring the amplitude (690) of the standing wave (306), comparing the amplitude (690) to the threshold (680) and storing an indication within the connectivity tester (152) that the standing wave (306) is not resonating.

Exemplary embodiments of the present invention are described largely in the context of a fully functional computer system for determining connectivity of a high speed link that includes an ac-coupling capacitor. Readers of skill in the art will recognize, however, that the present invention also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the invention as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of determining connectivity of a high speed link that includes an ac-coupling capacitor, the method comprising:
transmitting, by a connectivity tester, a test signal on a lane within the high speed link;
detecting on the lane, by the connectivity tester, a standing wave generated in response to the transmission of the test signal;
determining, by the connectivity tester, whether the standing wave is resonating;
if the standing wave is resonating, indicating, by the connectivity tester, that the lane of the high speed link has a closed connection; and
if the standing wave is not resonating, indicating, by the connectivity tester, that the lane of the high speed link has an open connection.

2. The method of claim 1, further comprising determining, by the connectivity tester, a length of the lane.

3. The method of claim 2, wherein determining a length of the lane includes receiving, by the connectivity tester, a user input indicating a type of the high speed link and wherein the determination of the length of the lane is based on the type of the high speed link.

4. The method of claim 2, further comprising:
based on the length of the lane, selecting, by the connectivity tester, a frequency of the test signal.

5. The method of claim 4, wherein the frequency of the test signal is selected such that the ratio of the length of the lane of the high speed link to the wavelength of the frequency of the test signal is an integer.

6. The method of claim 1, wherein determining whether the standing wave is resonating includes:
creating, by the connectivity tester, a spectrum illustrating the amplitude of the standing wave;
based on the spectrum, determining, by the connectivity tester, whether an amplitude of the standing wave is above a threshold;
if the amplitude of the standing wave is above the threshold, determining, by the connectivity tester, that the standing wave is resonating; and
if the amplitude of the standing wave is below the threshold, determining, by the connectivity tester, that the standing wave is not resonating.

7. The method of claim 1, wherein the ac-coupling capacitor is embedded within at least one connector of the high speed link.

8. Apparatus for determining connectivity of a high speed link that includes an ac-coupling capacitor, the apparatus comprising a computer processor, a computer memory operatively coupled to the computer processor, the computer memory having disposed within it computer program instructions capable of:
transmitting, by a connectivity tester, a test signal on a lane within the high speed link;
detecting on the lane, by the connectivity tester, a standing wave generated in response to the transmission of the test signal;
determining, by the connectivity tester, whether the standing wave is resonating;
if the standing wave is resonating, indicating, by the connectivity tester, that the lane of the high speed link has a closed connection; and
if the standing wave is not resonating, indicating, by the connectivity tester, that the lane of the high speed link has an open connection.

9. The apparatus of claim 8, further comprising determining, by the connectivity tester, a length of the lane.

10. The apparatus of claim 9, wherein determining a length of the lane includes receiving, by the connectivity tester, a user input indicating a type of the high speed link and wherein the determination of the length of the lane is based on the type of the high speed link.

11. The apparatus of claim 9, further comprising:
based on the length of the lane, selecting, by the connectivity tester, a frequency of the test signal.

12. The apparatus of claim 11, wherein the frequency of the test signal is selected such that the ratio of the length of the lane of the high speed link to the wavelength of the frequency of the test signal is an integer.

13. The apparatus of claim 8, wherein determining whether the standing wave is resonating includes:
creating, by the connectivity tester, a spectrum illustrating the amplitude of the standing wave;
based on the spectrum, determining, by the connectivity tester, whether an amplitude of the standing wave is above a threshold;
if the amplitude of the standing wave is above the threshold, determining, by the connectivity tester, that the standing wave is resonating; and
if the amplitude of the standing wave is below the threshold, determining, by the connectivity tester, that the standing wave is not resonating.

14. The method of claim 1, wherein the ac-coupling capacitor is embedded within at least one connector of the high speed link.

15. A computer program product for determining connectivity of a high speed link that includes an ac-coupling capacitor, the computer program product disposed upon a computer readable storage medium, the computer program product comprising computer program instructions capable, when executed, of causing a computer to carry out the steps of:
transmitting, by a connectivity tester, a test signal on a lane within the high speed link;
detecting on the lane, by the connectivity tester, a standing wave generated in response to the transmission of the test signal;
determining, by the connectivity tester, whether the standing wave is resonating;
if the standing wave is resonating, indicating, by the connectivity tester, that the lane of the high speed link has a closed connection; and
if the standing wave is not resonating, indicating, by the connectivity tester, that the lane of the high speed link has an open connection.

16. The computer program product of claim 15, further comprising determining, by the connectivity tester, a length of the lane.

17. The computer program product of claim 16, wherein determining a length of the lane includes receiving, by the connectivity tester, a user input indicating a type of the high speed link and wherein the determination of the length of the lane is based on the type of the high speed link.

18. The computer program product of claim 16, further comprising:
based on the length of the lane, selecting, by the connectivity tester, a frequency of the test signal.

19. The computer program product of claim 18, wherein the frequency of the test signal is selected such that the ratio of the length of the lane of the high speed link to the wavelength of the frequency of the test signal is an integer.

20. The computer program product of claim 15, wherein determining whether the standing wave is resonating includes:
creating, by the connectivity tester, a spectrum illustrating the amplitude of the standing wave;
based on the spectrum, determining, by the connectivity tester, whether an amplitude of the standing wave is above a threshold;
if the amplitude of the standing wave is above the threshold, determining, by the connectivity tester, that the standing wave is resonating; and
if the amplitude of the standing wave is below the threshold, determining, by the connectivity tester, that the standing wave is not resonating.
